(19) United States
(12) Patent Application Publication
(10) Pub. No.: US 2026/0252522 A1
(43) Pub. Date: Aug. 27, 2026

(54) ELECTRONIC DEVICE

(71) Applicant: STMicroelectronics International N.V., Geneva (CH)

(72) Inventor: Sylvain ENGELS, Meylan (FR)

(73) Assignee: STMicroelectronics International N.V., Geneva (CH)

(21) Appl. No.: 19/544,314

(22) Filed: Feb. 19, 2026

(30) Foreign Application Priority Data
Feb. 21, 2025 (FR) FR2501823

(51) Int. Cl. G06F 13/42; H04L 5/00

(52) U.S. Cl. CPC G06F 13/4269; G06F 13/4273; G06F 13/4278; H04L 5/0053

(57) ABSTRACT

An electronic device includes a first circuit configured to generate, after at least one event has been received on a first node, generate a request signal of a handshake protocol on a second node. After an acknowledgement signal of the handshake protocol has been received on a third node in response to the request signal, the first circuit generates a first signal on a fourth node authorizing the reception of at least one further event.

### PRIORITY CLAIM

This application claims the priority benefit of French Application for Patent No. FR2501823, filed on February 21, 2025, the content of which is hereby incorporated by reference in its entirety to the maximum extent allowable by law.

### TECHNICAL FIELD

The present disclosure generally concerns electronic devices and their associated operating methods.

### BACKGROUND

Digital electronic devices can operate in the synchronous domain, that is, synchronized with clock signals, or in the asynchronous domain, that is, for example, based on handshake protocols.

Digital devices are increasingly event-driven.

There exists a need to obtain electronic devices enabling to synchronize an event between a plurality of domains, be they asynchronous or synchronous.

There is a need to overcome all or part of the disadvantages of known devices.

### SUMMARY

An embodiment provides an electronic device comprising a first circuit configured to: after at least one event has been received on a first node, generate, on a second node, a request signal of a handshake protocol; and after an acknowledgement signal of said handshake protocol has been received on a third node as a response to said request signal, generate a first signal, on a fourth node, authorizing the reception of at least one further event.

An embodiment provides a method of operation of an electronic device comprising a first circuit, the method comprising: after at least one event has been received on a first node of the first circuit, generating, on a second node of the first circuit, a request signal of a handshake protocol; and after an acknowledgement signal of said handshake protocol has been received on a third node as a response to said request signal, generating a first signal, on a fourth node, authorizing the reception of at least one further event.

According to an embodiment, the first circuit is configured to operate with a first clock signal.

According to an embodiment, the event is in the form of a pulse having a duration shorter than or equal to one period of the first clock signal.

According to an embodiment, the first circuit comprises a first resynchronization cell, having an input coupled to the third node and a clock input configured to receive the first clock signal.

According to an embodiment, the first circuit comprises a first flip-flop, having an output coupled to the fourth node and an input coupled to an output of a first multiplexer; a first

input of the first multiplexer being coupled to ground; the first multiplexer having a control input coupled to the first node.

According to an embodiment, the first circuit comprises a second multiplexer having: a control input coupled to the first node; an output coupled to an input of a state storage element; a first input coupled to a first output of the state storage element; and a second input coupled, via an inverter, to a first output of the first resynchronization cell; the state storage element having a second output, inverse to the first output, coupled to the second node.

According to an embodiment: a second input of the first multiplexer is coupled to an output of a third multiplexer; a first and a second inputs of the third multiplexer being respectively coupled to the fourth node and to a voltage rail configured to receive a first voltage; the state storage element is a flip-flop; and a control input of the third multiplexer is coupled to an output of a block configured so that if the request signal is at the same level as a second signal present on the first output of the first resynchronization cell, then the second input of the third multiplexer is selected.

According to an embodiment, the first circuit comprises a counter coupled to the first multiplexer and to the fourth node, and configured to: increment when an event is received on the first node; decrement when the request signal is at the same level as a second signal present on the first output of the first resynchronization cell; and activate the first signal as long as a threshold of the counter has not been reached, and deactivate it when said threshold has been reached.

According to an embodiment, the first circuit is coupled to a second circuit operating synchronously with the first clock signal, and configured so as to generate events and to

supply them to the first node of the first circuit as long as the first signal is activated, and to stop supplying events to the first node of the first circuit when the first signal is deactivated.

According to an embodiment, the first circuit is coupled to a third circuit configured to generate said acknowledgement signal of said handshake protocol on a fifth node, as a response to the request signal of said handshake protocol.

According to an embodiment, the third circuit is configured so that, as a response to the request signal of said handshake protocol, an output event is generated on an output node of the third circuit.

According to an embodiment, the fifth node is coupled to the third node of the first circuit, and the third circuit comprises: a sixth node coupled to the second node of the first circuit; a second resynchronization cell having a clock input configured to receive a second clock signal, an input coupled to the sixth node, and an output coupled to a logic block configured to obtain on the output node the result of an exclusive OR function from the signal present on the fifth node and a third signal present on the output of the second resynchronization cell; and a flip-flop having an input coupled to said output of the resynchronization cell, a clock input configured to receive the second clock signal, and an output coupled to the fifth node.

According to an embodiment, the state storage element is a multi-bit register, or a memory operating according to the first-in-first-out principle.

According to an embodiment, the state storage element is a memory operating according to the last-in-first-out principle.

According to an embodiment, the electronic device is a microcontroller.

According to an embodiment, the electronic device comprises an NFC circuit.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows a simplified view of an example of an electronic device;

FIG. 2 very schematically shows an example of functional blocks of the electronic device of FIG. 1;

FIG. 3 very schematically shows an embodiment of FIG. 2;

FIG. 4 shows an embodiment of a block of FIG. 3;

FIG. 5 shows an embodiment of a block of FIG. 3;

FIG. 6 schematically shows an embodiment of FIG. 2;

FIG. 7 shows an embodiment of a block of FIG. 6;

FIG. 8 schematically shows an embodiment of FIG. 2;

FIG. 9 shows an embodiment of blocks of FIG. 8;

FIG. 10 shows an operating timing diagram of the example of FIG. 4;

FIG. 11 shows an operating timing diagram of the example of FIG. 7; and

FIG. 12 shows an operating timing diagram of the example of FIG. 9.

### DETAILED DESCRIPTION

The same elements have been designated by the same references in the various figures. In particular, structural and/or functional elements common to the different embodiments may have the same references and may have identical structural, dimensional and material properties.

For the sake of clarity, only those steps and elements that are useful for understanding the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms "front", "back", "top", "bottom", "left", "right", etc., or relative position qualifiers, such as the terms "top", "bottom", "upper", "lower", etc., or orientation qualifiers, such as "horizontal", "vertical", etc., reference is made unless otherwise specified to the orientation of the drawings.

Unless specified otherwise, the expressions "about", "approximately", "substantially", and "in the order of" signify plus or minus 10% or 10°, preferably of plus or minus 5% or 5°.

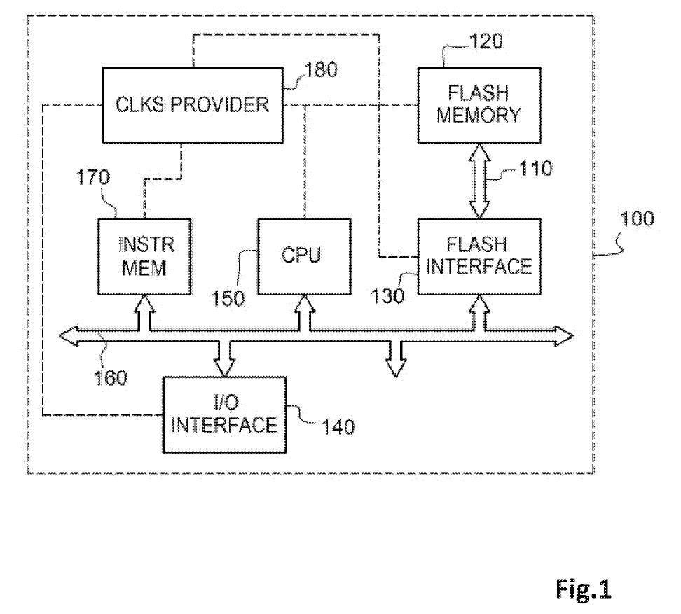

FIG. 1 shows a simplified view of an example of an electronic device 100. Device 100 is, for example, a microcontroller and/or a wireless communication device, for example of NFC or RFID type, for example, according to the ISO 14443 RF standard.

Circuit 100 comprises, for example, a memory 120 (FLASH MEMORY), for example, non-volatile, or of FLASH memory type, capable of communicating, via a communication bus 110, for example with a memory interface 130 (FLASH INTERFACE) configured to write or read data into and from non-volatile memory 120.

Circuit 100 further comprises, for example, a processing unit 150 (CPU) comprising one or more processors under control of instructions stored in an instruction memory 170 (INSTR MEM). Instruction memory 170 is, for example, a volatile random access memory (RAM). Processing unit 150 and memory 170 communicate, for example, via a system (data, address, and control) bus 160. Memory 120 is coupled to system bus 160 via non-volatile memory interface 130 and via bus 110. Device 100 further comprises, for example, an input/output interface 140 (I/O interface) coupled to system bus 160 to communicate with the outside.

Device 100 may integrate other circuits implementing other functions (for example, one or more volatile and/or non-volatile memories, other processing units), not illustrated in FIG. 1. Among these other circuits, device 100 comprises, for example, a read-only or static memory, or circuits allowing the implementation of a wireless communication with the outside of device 100.

Some or all of the various elements 110, 120, 130, 140, 150, 160, 170, 180 may have a digital operation. In this case, the timing of their operations is, for example, obtained by using one or more clock signals representing a sequence of pulses, for example in square-wave form, alternating between a high state (logic 1) and a low state (logic 0). In another example, the operations may have an operation based on a handshake protocol, involving requests (or request signals) and acknowledgements (or acknowledgement signals), or implementing ready/valid data.

An example of a communication protocol of the buses of device 100 is the advanced scalable interface (AXI), which is part of the Advanced Microcontroller Bus Architecture (AMBA) specification.

An example of an AXI protocol defines a basic contact mechanism, formed of a valid and ready signal. The valid signal is driven by the source to inform the destination entity that the payload on the channel is valid and can be read from a clock cycle. Similarly, the ready signal is driven by the receiving entity to notify that it is ready to receive data.

Circuit 100 comprises, for example, a block 180 (CLKS PROVIDER) for delivering one or more clock signals. This provider block is, for example, coupled, preferably connected, to one or all of elements 110,120, 130, 140, 150, 160, 170.

Provider block 180 may provide a plurality of clock signals, for example with different frequencies, to the elements to which it is connected.

In another example, some or all of the various elements 110, 120, 130, 140, 150, 160, 170, 180 may have an event-driven operation. These events are, for example, in the form of a pulse, represented, for example, by the switching to the high state for a time shorter than or equal to one period of a clock signal before returning to the low state.

The various elements 110, 120, 130, 140, 150, 160, 170, 180, or their internal circuits, may need to synchronize an event, even though they use clock signals of different frequencies, or while one of these elements, or circuits, uses a handshake protocol (asynchronous operation) and another operates synchronously, that is, its operation is synchronized with a clock signal.

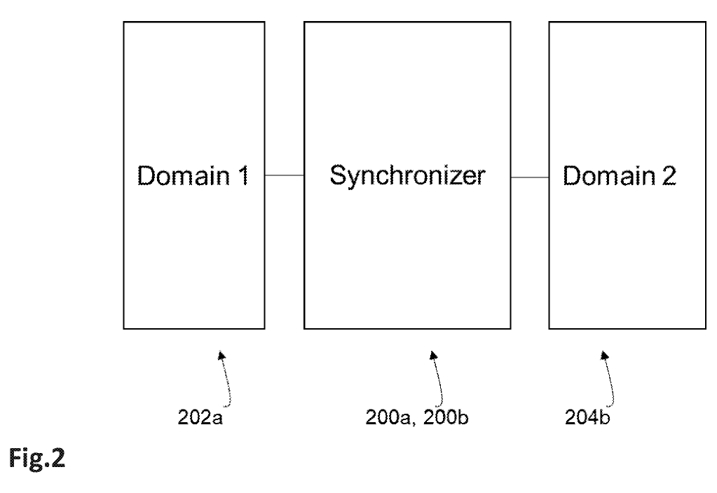

FIG. 2 schematically shows an example of functional blocks of the electronic device 100 of FIG. 1.

More particularly, the example of FIG. 2 shows a block or a circuit 202a (Domain 1) which is, for example, one of the various elements 110, 120, 130, 140, 150, 160, 170, 180, or one of their internal circuits.

The example in FIG. 2 also shows another block or circuit 204b (Domain 2) which is, for example, another of elements 110, 120, 130, 140, 150, 160, 170, 180, or another of their internal circuits.

Block or circuit 202a and block or circuit 204b are coupled by a circuit (Synchronizer) which may be formed of a circuit 200a, or of a circuit 200b, or of the two circuits 200a and 200b in series. Circuits 200a and 200b allow, when they are associated in series, an event synchronization between the two domains 202a and 204b, for example when they each uses a clock signal of different frequency.

When the power consumption is desired to be limited, a strategy comprises using an approach based on the generation of events. However, the synchronization of an event in the form of a pulse does not work with standard architectures of synchronization circuits. Further, in the case of contactless applications, such as, for example, for an NFC communication, the clock signals may suddenly disappear and thus cause a failure of circuit 200a, 200b. In these cases, existing architectures of circuit 200a, 200b do not apply.

Indeed, a solution may be to transform the event into a level and to use a standard synchronization circuit to synchronize the edge (rising or falling). In this case, circuit 200a, 200b needs to hold the level for the entire duration of the synchronization, which may greatly impact the general latency of device 100.

A solution may be based on the use of a circuit of mutual exclusion (Mutex) type, which is a synchronization primitive used in computer programming to avoid for shared system resources to be used at the same time. However, this is done without any link to the clock signals, and this implies that circuit 200a, 200b is then not a synchronization circuit.

Several aspects are addressed in the following.

A first aspect addresses the case where a circuit (for example, circuit 202a, or for example, one of elements 110, 120, 130, 140, 150, 160, 170, 180, or one of their internal circuits) is of synchronous type and generates one or more input events finally intended for a circuit (for example, circuit 200b or for example, another of elements 110, 120, 130, 140, 150, 160, 170, 180, or another of their internal circuits) using a request signal and an acknowledgement signal of a handshake-type protocol in its operation. Circuit 200a must thus be able to transform the event(s) from circuit 202a to circuit 200b and to be able to manage the acknowledgement signal generated as a response to the request signal.

A second aspect addresses the case where a circuit (for example, circuit 200a or for example, one of elements 110, 120, 130, 140, 150, 160, 170, 180, or one of their internal circuits) operates by delivering a request signal and receiving an acknowledgement signal of a handshake-type protocol. Circuit 200b thus needs to be able to synchronize the request signal originating from, for example, circuit 200a, or for example from another of elements 110, 120, 130, 140, 150, 160, 170, 180, or another of their internal circuits, to generate respective events for circuit 204b, which is of synchronous type.

A third aspect addresses the case where circuit 202a is synchronous and generates one or more events for circuit 204b, which is also of synchronous type but with a clock frequency different from that of circuit 202a. It is thus necessary to be able to synchronize the event(s) between these circuits 202a and 204b.

First aspect:

In order to overcome the above-mentioned disadvantages, embodiments of the first aspect provide an electronic device comprising a first circuit configured to: after at least one event has been received on a first node, generate, on a second node, a request signal of a handshake protocol; and after an acknowledgement signal of said handshake protocol has been received on a third node as a response to said request signal, generate a first signal, on a fourth node, authorizing the reception of at least another event.

This allows in particular a low-power operation.

This also enables to store the event in the first circuit and to withstand the phenomenon of clock vanishing in circuit 204b.

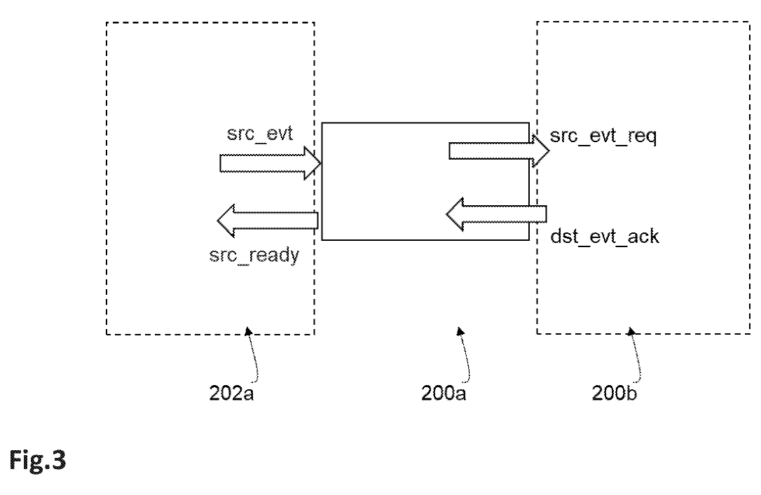

FIG. 3 schematically shows an embodiment of FIG. 2.

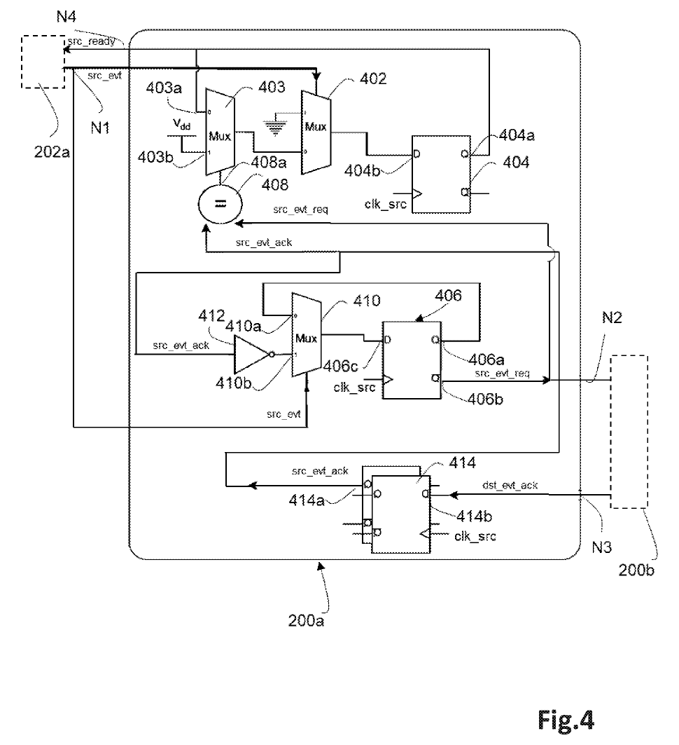

FIG. 4 shows an embodiment of a block of FIG. 3.

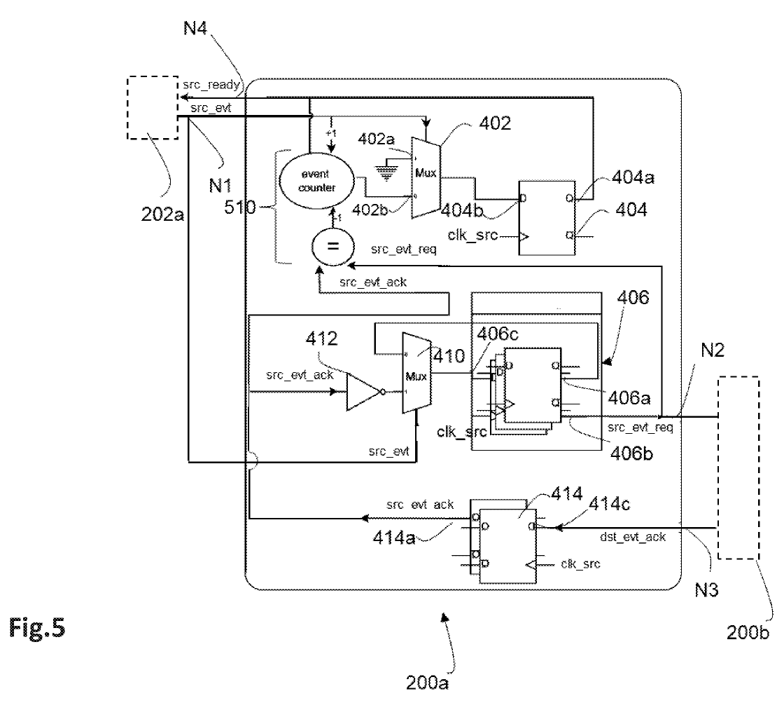

FIG. 5 shows an embodiment of a block of FIG. 3.

More particularly, FIGS. 3 to 5 refer to the first aspect.

In the example of FIG. 3, circuit 202a is a synchronous circuit using a clock signal src_clk. Circuit 204b uses an operation based on a handshake protocol.

In an example, circuit 202a is configured so as to generate events src_evt, for example in the form of pulses having a duration shorter than or equal to one period of clock signal src_clk, and to supply them to circuit 200a.

Circuit 202a is here considered as the event source circuit, and circuit 200b is the destination circuit, receiving events transformed into a request signal by circuit 200a.

After at least one event has been received by circuit 200a, it generates a request signal src_evt_req of a handshake protocol.

In an example, circuit 200b is configured to generate the acknowledgement signal dst_evt_ack of the handshake protocol as a response to the request signal src_evt_req sent by circuit 200a as a result of the reception of the event on signal src_evt.

After the acknowledgement signal has been received by circuit 200a, it generates a signal src_ready.

In an example, as long as the signal src_ready supplied by circuit 200a is activated, that is, in the high state for example, the reception of at least one further event by circuit 200a is activated, or the generation by circuit 202a of a further event is activated. In an example, circuit 202a is configured to stop supplying events to circuit 200a when signal src_ready is deactivated, that is, for example, in the low state. In another example, the reception of at least one further event by circuit 200a is deactivated when signal src_ready is deactivated. Signal src_ready is, for example, of the same type as the ready signal of the AXI protocol.

In the example of FIG. 4, circuit 200a is coupled to circuit 202a by a node N1 and a node N4. Circuit 202 generates events src_evt on the node N1 of circuit 200a, and circuit 200a generates signal src_ready on node N4.

In the example of FIG. 4, circuit 200a is coupled to circuit 200b by a node N2 and a node N3. After at least one event has been received by circuit 200a, it generates the associated the request signal src_evt_req associated with the handshake protocol on node N2.

Circuit 200b is configured to generate, as a response to the request signal src_evt_req sent by circuit 200a, the acknowledgement signal dst_evt_ack of the handshake protocol on node N3.

In the example of FIG. 4, circuit 200a comprises a first resynchronization cell 414, otherwise called register cell, having an input 414b coupled to node N3 and a clock input configured to receive clock signal clk_src. Resynchronization cell 414 comprises, for example, first and second flip-flops, for example, D flip-flops, in series. In an example, these flip-flops form a shift register. In an example, these two flip-flops are of rising edge detection type. A first one of the flip-flops comprises, for example, a clock input, a reset input, and a so-called enable input D, which is input 414b. An output of the first flip-flop is coupled to the input of the second flip-flop. The output of the second flip-flop is called 414a.

In the shown example, circuit 200a comprises a flip-flop 404, having an output 404a coupled to the fourth node N4 and an input 404b coupled to an output of a multiplexer 402. A first input 1 of multiplexer 402 is, for example, coupled, preferably connected, to ground. Multiplexer 402 has, for example, a control input coupled, preferably connected, to node N1.

In the example of FIG. 4, a second input 0 of multiplexer 402 is coupled to an output of a multiplexer 403. A first and a second inputs 403a, 403b of multiplexer 403 are respectively coupled to node N4 and to a voltage rail configured to receive a voltage, for example Vdd. A control input of multiplexer 403 is coupled to an output 408a of a block 408.

In an example, block 408 is configured so that if request signal src_evt_req is at the same level as a signal src_evt_ack present on output 414a of resynchronization cell 414, then the input 403b of multiplexer 403 is selected. This enables to "lock" the request seen from the source domain. In an example, block 408 is configured so that if request signal src_evt_req is at the same level as the signal src_evt_ack present on output 414a of resynchronization cell 414, and they are both at the low level, then input 403b of multiplexer 403 is selected.

Circuit 200a comprises, for example, another multiplexer 410 having a control input coupled, preferably connected, to node N1. Multiplexer 410 has, for example, an output coupled to an input 406c of a state storage element 406. State storage element 406 is for example a flip-flop, for example a D-type flip-flop, or for example a register. Multiplexer 410 has, for example, an input 410a coupled, preferably connected, to an output 406a of state storage element 406. Multiplexer 410 further has, for example, an input 410b coupled, via an inverter 412, to an output 414a of resynchronization cell 414.

In the illustrated example, state storage element 406 has, for example, a second output 406b, which is the inverse of the first output 406a (that is, the state present on output 406b is inverted with respect to that on output 406a), coupled, preferably connected, to node N2.

The shown circuit 200a enables to transport event src_evt over a control path, compatible with a handshake protocol, for transforming an event into a control event. The control path then is a path different from a data path. The control event is then synchronized with circuit 204. While the event is not maintained over time, the request signal src_evt_req generated on node N2 is maintained as long as it is not deactivated after a corresponding acknowledgement signal dst_evt_ack has been received on node N3.

Request signal src_evt_req is received on node N2, and acknowledgement signal dst_evt_ack is received on node N3.

As a result of the reception of an event src_evt on node N1, request signal src_evt_req is set to the high state, for example, and is held in this state as long as circuit 200b has not set acknowledgement signal dst_evt_ack to the high state on node N3. Once acknowledgement signal dst_evt_ack has been set to the high state, signal src_ready is then activated, for example, set to the high state, and request signal src_evt_req is deactivated, for example, set to the low state or to zero.

In an example, resynchronization cell 414, block 408, and multiplexer 403 are optional. In this case, request signal src_evt_req is reset by another mechanism. This example can be applied in the case where the source can produce a level and it is desired to have an event in the destination, for example during an interrupt.

The example of FIG. 5 is similar to that of FIG. 4, except that block 408 and multiplexer 403 are replaced with a block 510. Block 510 is coupled to the first multiplexer 402 and to node N4, and is configured to increment when an event src_evt is received on node N1.

In an example, block 510 is also configured to decrement when request signal src_evt_req is at the same level as a signal src_evt_ack present on output 414a of resynchronization cell 414. In another example, block 510 is configured to decrement when request signal src_evt_req and the signal src_evt_ack present on output 414a of resynchronization cell 414 are equal and at the low level.

In an example, block 510 is further configured to activate signal src_ready as long as a threshold of the counter has not been reached, and to deactivate it when said threshold has been reached.

In the example of FIG. 5, state storage element 406 is no longer a flip-flop or a register as in FIG. 4, but is, for example, either a multi-bit register, or a memory operating according to the first-in-first-out (FIFO) principle, or a memory operating according to the last-in-first-out (LIFO) principle.

The storage element 406 of FIG. 5 will store all requests, in the order of arrival or in another order, before their sequential sending to node N2. An unordered storage enables to decrease the required memory space.

The examples of FIGS. 4 and 5 allow, for example, the use of the so-called "4-phase" or "2-phase" protocols.

Second aspect:

To address the case where a source circuit generates one or more events in the form of a request signal addressed to a circuit which, in turn, is of synchronous type, the embodiments of the second aspect provide for the electronic device to comprise a first circuit configured to, as a response to a request signal src_evt_req of a handshake protocol, generate an acknowledgement signal dst_evt_ack of a handshake protocol, and generate an event dst_evt for the destination circuit.

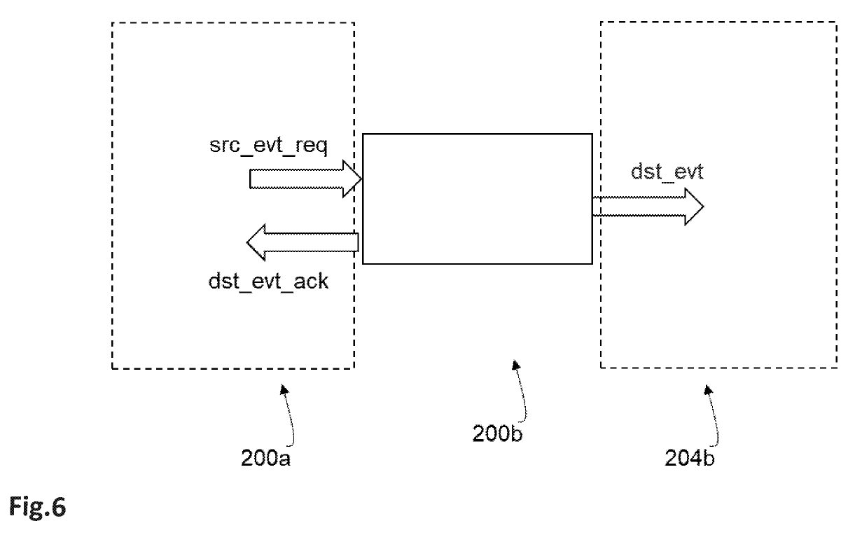

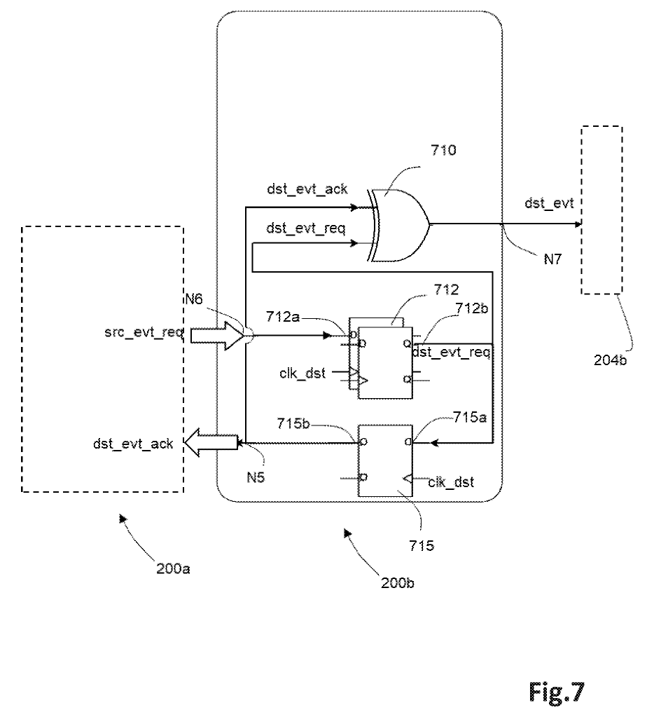

FIGS. 6 and 7 relate to the second aspect.

FIG. 6 schematically shows an embodiment of FIG. 2.

FIG. 7 shows an embodiment of a block of FIG. 6.

In the example of FIG. 6, circuit 200a, which is, for example, that of FIGS. 4 or FIG. 5, is a circuit which provides, or operates according to, a handshake protocol. Circuit 200b operates with a clock signal clk_dst. In this example, circuit 200a generates a request signal src_evt_req addressed to circuit 200b, and processes the corresponding acknowledgement signal dst_evt_ack returned by circuit 200b.

Circuit 200b will, as a response to request signal src_evt_req, form one or more events dst_evt sent to circuit 204b.

Circuit 200a uses, for example, clock signal clk_src.

Circuit 204b is, for example, synchronous and configured to operate with a clock signal clk_dst having a frequency equal to or different from that of signal clk_src.

In an example, the events dst_evt generated by circuit 200b, as a response to the level change of the request signal, are in the form of a pulse having a duration shorter than or equal to one period of clock signal clk_dst.

In the example of FIG. 7, circuit 200b comprises a resynchronization cell 712 having a clock input configured to receive clock signal clk_dst. Resynchronization cell 712 further comprises an input 712a coupled to a node N6 configured to receive request signal src_evt_req.

Resynchronization cell 712 also has an output 712b coupled, for example, to a logic block 710. Logic block 710 is, for example, configured to obtain, on a node N7, the result of an exclusive OR type function from the signal dst_evt_ack present on a node N5 and a signal dst_evt_req present on the output 712b of resynchronization cell 712. Events dst_evt are thus generated on node N7.

In the illustrated example, circuit 200b comprises a flip-flop 715, for example a D-type flip-flop, having an input 715a coupled to the output 712b of resynchronization cell 712. A clock input of flip-flop 715 is configured to receive clock signal clk_dst, and an output 715b of flip-flop 715 is coupled to the node N5 having acknowledgement signal dst_evt_ack formed thereon.

In the shown example, circuit 200b is coupled, via node N7, to circuit 204b.

Third aspect:

The third aspect addresses the case where circuit 202a is synchronous and generates one or more events for circuit 204b, which is also of synchronous type but with a clock frequency different from that of circuit 202a. It is thus necessary to be able to synchronize the event(s) between these circuits 202a and 204b.

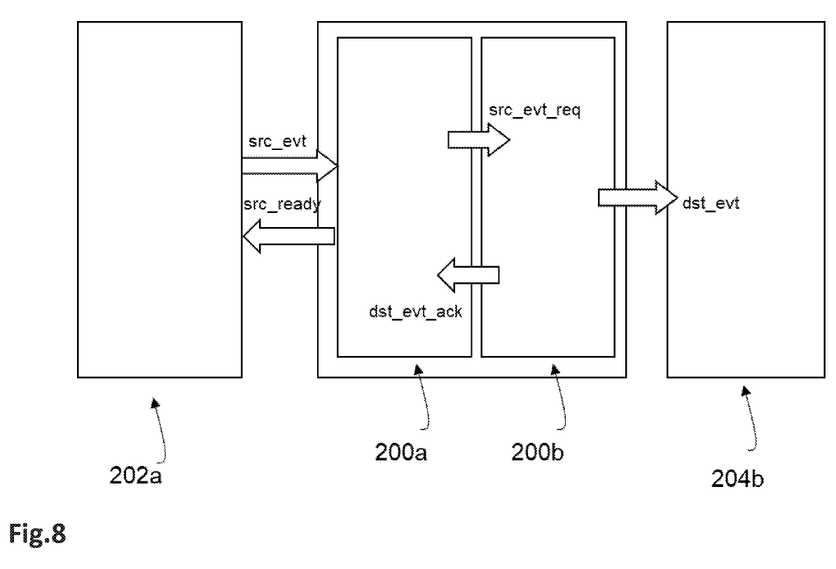

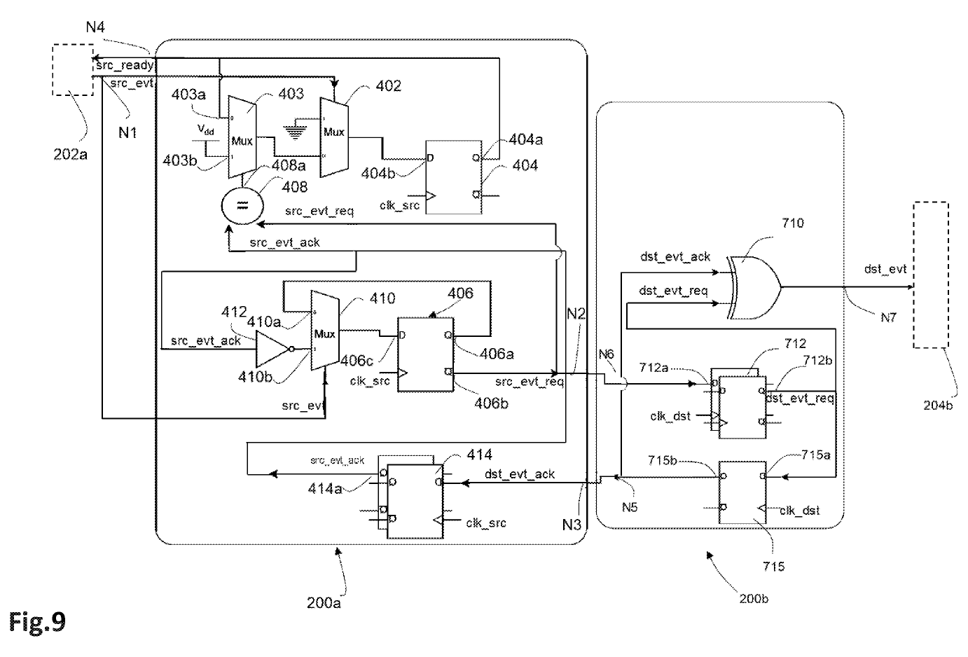

FIGS. 8 and 9 deal with the third aspect.

FIG. 8 schematically shows an embodiment of FIG. 2.

FIG. 9 shows an embodiment of blocks of FIG. 8.

In the example of FIG. 8, circuit 202a operates synchronously with clock signal clk_src, and circuit 204b is synchronous with signal clk_dst.

Circuit 202a generates events src_evt for circuit 200a. Circuit 200a, as a response to the events, generates state variations of request signal src_evt_req for circuit 200b. As a response to these requests, circuit 200b generates respective acknowledgement signals dst_evt_ack for circuit 200a and also generates respective events dst_evt for circuit 204b.

As a response to the respective level or state variations of the acknowledgement signal, circuit 200a activates, or keeps active, signal src_ready to signify that new events can be processed by circuit 200a.

In the example of FIG. 9, circuits 200a and 200b are identical to those of FIGS. 4 and 7 respectively. Node N2 of circuit 200a is coupled, preferably connected, to the node N6 of circuit 200b, and node N3 of circuit 200a is coupled, preferably connected, to the node N5 of circuit 200b. In this example, circuits 200a and 200b are coupled, preferably connected, respectively to circuits 202a and 204b, similarly to the examples of FIGS. 4 and 7.

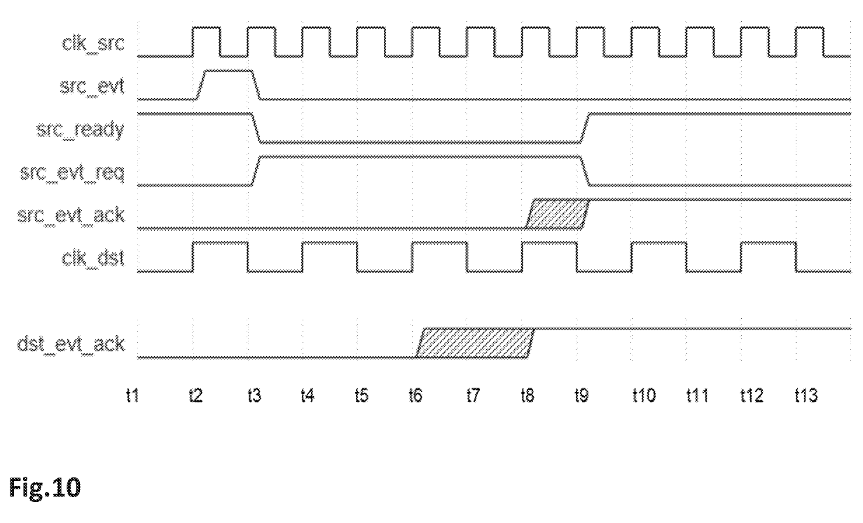

FIG. 10 shows a timing diagram of operation of the example of FIG. 4.

The timing diagram of FIG. 10 shows signals clk_src, src_evt, src_ready, src_evt_req, src_evt_ack, clk_dst, and dst_evt_ack. In the example of FIG. 10, signal clk_dst has a frequency divided by two as compared with signal clk_src.

Between a time t1 and a time t2, signals clk_src, src_evt, src_evt_req, src_evt_ack, and clk_dst are in the low state, or logic zero, and signal src_ready is in the high state, in other words logic high, activated, which authorizes the processing of an event by circuit 200a.

At time t2, the two signals clk_src and clk_dst start alternating square-wave signals. The rising edges of signal clk_src are at times t2, t3, t4, t5, t6, t7, t8, t9, t10, t11, t12, and t13. The rising edges of signal clk_dst are at times t2, t4, t6, t8, t10, and t12.

At time t2, an event is present on signal src_evt in the form of a pulse having a duration equal to one period of signal clk_src.

At the next clock signal of signal clk_src, request signal src_evt_req rises and remains in the high or logic 1 state, and signal src_ready is deactivated to stop the reception of events.

Request signal src_evt_req is processed by circuit 200b, or by another circuit managing a handshake protocol, and this takes a plurality of clock strokes.

At time t6 or t8 (shaded area depending on the time taken by circuit 200b), circuit 200b switches signal dst_evt_ack to the high state, where it then remains.

At time t8 or t9 (shaded area depending on the time taken by circuit 200b in the previous step), signal src_evt_ack switches to the high state, signal src_ready is activated again, which allows the reception of a new event, after which request signal src_evt_req is set to the low state, indicating that the request is over.

In the case of a 4-phase protocol, signal dst_evt_ack is set back to the low state, or logic 0, before a new request. In the case of the 2-phase protocol, signal dst_evt_ack is set back to the low state, or logic 0, at the time of a new request which will switch the request signal to the low state, or logic 0. In the shown example, the request is indicated by a polarity change. In this case, the acknowledgement signal follows the same logic.

After time t9, signals src_evt_ack, src_evt_req, src_ready, and dst_evt_ack remain constant respectively in the high state, in the low state, in the high state, and in the high state.

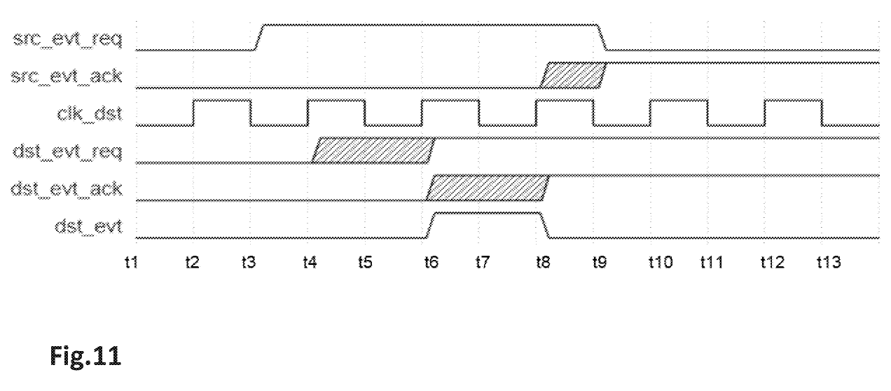

FIG. 11 shows a timing diagram of operation of the example of FIG. 7.

The timing diagram of FIG. 11 shows signals src_evt_req, src_evt_ack, clk_dst, dst_evt_req, dst_evt_ack, and dst_evt.

Between a time t1 and a time t2, signals src_evt_req, clk_dst, dst_evt_req, dst_evt_ack, and dst_evt are in the low state, or zero.

The rising edges of signal clk_dst are at times t2, t4, t6, t8, t10, and t12.

At a time t3, which is for example at the level of a falling edge of signal clk_dst, request signal src_evt_req is set to the high state or logic 1 until a time t9.

At time t4 (or t6 depending on the processing time of resynchronization cell 712), signal dst_evt_req switches to and then remains in the high state.

At time t6 (or time t8 depending on the previous step), signal dst_evt_ack switches to and remains in the high state.

At time t6, signal dst_evt further switches to the high state, to fall back at time t8 to the low state, that is, during a period of clock signal clk_dst, which creates a synchronized event for circuit 204b, which also operates with clock signal clk_dst.

At time t9, request signal src_evt_req is set to the low or logic 0 state as a response to the acknowledgement signal dst_evt_ack being set to the high state at time t6 or t8.

After time t9, signals dst_evt_req and dst_evt_ack remain in the high state, for example, until the next setting to the high state of request signal src_evt_req.

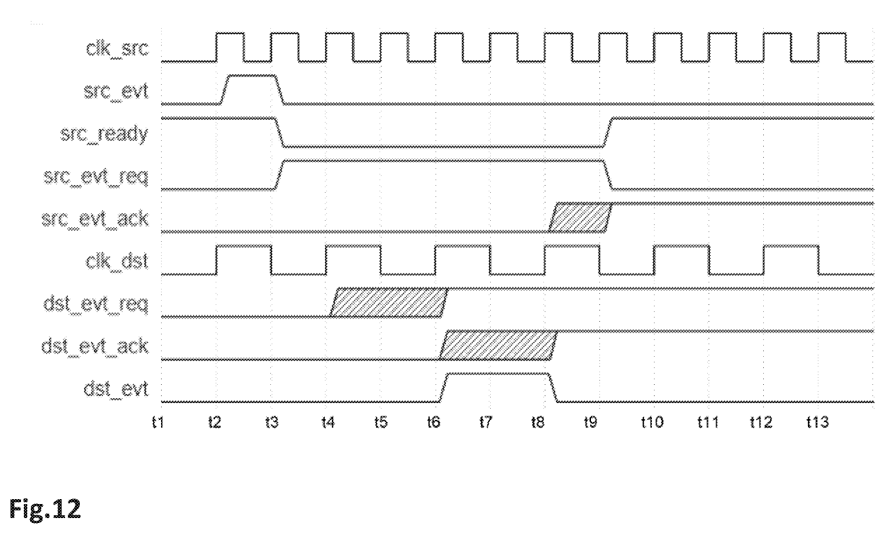

FIG. 12 shows a timing diagram of operation of the example of FIG. 9.

The timing diagram of FIG. 12 shows signals clk_src, src_evt, src_ready, src_evt_req, src_evt_ack, clk_dst, dst_evt_req, dst_evt_ack, and dst_evt.

The timing diagram of FIG. 12 is the combination of the timing diagrams of FIGS. 10 and 11, keeping times t1 to t13 similar.

In the timing diagram of FIG. 12, an event is generated by circuit 202a, which is synchronous with signal clk_src, on signal src_evt, between times t2 and t3, which corresponds to a period of clock signal clk_src. This event is transformed by circuit 200a into a request signal src_evt_req of a handshake protocol. As a response to this request signal, circuit 200b generates an event on signal dst_evt, which is synchronous with signal clk_dst, between times t6 and t8, which corresponds to a period of signal clk_dst. Signal 200b also generates, as a response to request signal src_evt_req, an acknowledgement signal dst_evt_ack, which is received and processed by circuit 200a at time t6 or t8 depending on the processing speed, so as to activate signal src_ready indicating that a new event can be received by circuit 200a and to lower the request signal src_evt_req sent to circuit 200b.

The following examples of embodiments concern the second and third aspects. In the following examples, circuit 200a is called the third circuit, circuit 202a is called the fourth circuit, circuit 200b is called the first circuit, and circuit 204b is called the second circuit. The terms first, second, third, and fourth do not refer to an order but are used to name the different circuits.

Example 1: Electronic device 100 comprising a first circuit 200b configured to, as a response to a request signal src_evt_req of a handshake protocol, generate an acknowledgement signal dst_evt_ack of a handshake protocol, and generate an output event dst_evt.

Example 2: Method of operation of an electronic device 100 comprising the generation, as a response to a request signal src_evt_req of a handshake protocol and with a first

circuit 200b, of an acknowledgement signal dst_evt_ack of a handshake protocol, and of an output event dst_evt.

Example 3: Device according to example 1 or method according to example 2, in which the first circuit 200b is configured to operate with a first clock signal clk_dst.

Example 4: Device or method according to Example 3, in which the generated output event is in the form of a pulse having a duration shorter than or equal to one period of the first clock signal clk_dst.

Example 5: Device or method according to Example 3 or 4, wherein the first circuit 200b comprises: a first resynchronization cell 712 having a clock input configured to receive the first clock signal clk_dst, an input 712a coupled to a first node N6 configured to receive request signal src_evt_req, and an output 712b coupled to a logic block 710 configured to obtain on an output node N7 the result of an exclusive OR type function from the signal present on a second node N5 and a first signal dst_evt_req present on the output 712b of the first resynchronization cell 712.

Example 6: Device or method according to example 5, in which the first circuit 20b comprises a flip-flop 715 having an input 715a coupled to said output 712b of the first resynchronization cell 712, a clock input configured to receive the first clock signal clk_dst, and an output 715b coupled to the second node N5 having acknowledgement signal dst_evt_ack formed thereon.

Example 7: Device according to any of Examples 1, or 3 to 6, or method according to any of Examples 2 to 6, in which the first circuit 200b is coupled, via output node N7, to a second circuit 204b operating synchronously with the first clock signal clk_dst.

Example 8: Device according to any of Examples 1, or 3 to 7, or method according to any of Examples 2 to 7, in which the first node N6 and the second node N5 of the first circuit 200b are respectively coupled, preferably connected, to a first output node N2 and to a first input node N3 of a third circuit 200a.

Example 9: Device or method according to Example 8, wherein the third circuit 200a is configured to generate said request signal src_evt_req of said handshake protocol on the first output node N2 and to receive said acknowledgement signal dst_evt_ack of said handshake protocol on the first input node N3.

Example 10: Device or method according to Example 9, in which the third circuit 200a is configured to: after at least one input event src_evt has been received on a second input node N1 of the third circuit 200a, generate, on the first output node N2, said request signal src_evt_req; and after said acknowledgement signal dst_evt_ack, has been received on the first input node N3 as a response to said request signal, generate a second output signal src_ready, on a second output node N4, authorizing the reception of at least another input event on the second input node N1.

Example 11: Device or method according to any of Examples 8 to 10, in which the third circuit 200a is configured to operate with a second clock signal clk_src.

Example 12: Device or method according to Example 11, in which the input event is in the form of a pulse having a duration shorter than or equal to one period of the second clock signal clk_src.

Example 13: Device or method according to any of Examples 8 to 12, in which the third circuit 200a comprises a second resynchronization cell 414, having an input 414c coupled to the first input node N3 and a clock input configured to receive the second clock signal clk_src.

Example 14: Device or method according to Example 13, in which the third circuit 200a comprises a second flip-flop 404, having an output 404a coupled to the second output node N4 and an input 404b coupled to an output of a first multiplexer 402.

Example 15: Device or method according to example 14, in which a first input 402a of the first multiplexer 402 is coupled to ground.

Example 16: Device or method according to Example 14 or 15, in which the first multiplexer 402 has a control input coupled to the second input node N1.

Example 17: Device or method according to any of Examples 13 to 16, in which the third circuit 200a comprises a second multiplexer 410 having: a control input coupled to the second input node N1; an output coupled to an input 406c of a state storage element 406; a first input 410a coupled to a first output 406a of the state storage element 406; and a second input 410b coupled via an inverter 412 to a first output 414a of the second resynchronization cell 414.

Example 18: Device or method according to Example 17, in which state storage element 406 has a second output 406b, inverse to the first output 406a, and coupled to the first output node N2.

Example 19: Device or method according to Example 17 or 18, in which a second input 402b of the first multiplexer 402 is coupled to an output of a third multiplexer 403.

Example 20: Device or method according to Example 20, in which a first and a second inputs 403a, 403b of the third multiplexer 403 are respectively coupled to the second output node N4 and to a voltage rail configured to receive a first voltage Vdd.

Example 21: Device or method according to example 20, in which state storage element 406 is a flip-flop.

Example 22: Device or method according to example 20 or 21, in which a control input of the second multiplexer 403 is coupled to an output 408a of a block 408 configured so that if request signal src_evt_req is at the same level as a third signal src_evt_ack present on an output 414a of the second resynchronization cell 414, then the second input 403b of the third multiplexer 403 is selected.

Example 23: Device or method according to Example 18, in which the third circuit 200a comprises a counter 510 coupled to the first multiplexer 402 and to the second output node N4, and configured to: increment when an input event is received on the second input node N1; decrement when the request signal src_evt_req is at the same level as a fourth signal src_evt_ack present on the output 414a of the second resynchronization cell 414; and activate the second output signal src_ready as long as a counter threshold has not been reached, and deactivate it when said threshold has been reached.

Example 24: Device or method according to any of Examples 17 to 23 in which state storage element 406 is a multi-bit register.

Example 25: Device or method according to any of Examples 17 to 23 in which state storage element 406 is a memory operating according to the first-in-first-out, FIFO, principle.

Example 26: Device or method according to any of Examples 17 to 23 in which state storage element 406 is a memory operating according to the last-in-first-out, LIFO, principle.

Example 27: Device or method according to any of Examples 17 to 26, in which the third circuit 200a is coupled to a fourth circuit 202a operating synchronously with the second clock signal clk_src.

Example 28: Device or method according to Example 27, in which the fourth circuit 202a is configured to generate input events and to supply them to the second input node N1 of the third circuit 200a as long as the second output signal src_ready is activated, and to stop supplying input events to the second input node N1 of the third circuit 200a when the second output signal src_ready is deactivated.

Example 29: Device according to any of Examples 1, or 3 to 28, or method according to any of Examples 2 to 28, wherein electronic device 100 is a microcontroller.

Example 30: Device according to any of Examples 1, or 3 to 29, or method according to any of Examples 2 to 29, wherein electronic device 100 comprises an NFC circuit.

Various embodiments and variants have been described. Those skilled in the art will understand that certain features of these various embodiments and variants may be combined, and other variants will occur to those skilled in the art. In particular, the disclosed embodiments can be applied to synchronization between different power supply levels.

Finally, the practical implementation of the described embodiments and variants is within the abilities of those skilled in the art based on the functional indications given hereabove. In particular, with regard to the examples of FIGS. 3 to 5, even though circuit 200b is indicated as the circuit using the request signals src_evt_req originating from circuit 200a and generating as

a response acknowledgement signals dst_evt_ack, those skilled in the art will be capable of implementing, instead of circuit 200b, another circuit using a handshake protocol capable of managing the requests src_evt_req originating from circuit 200a and of generating as a response the respective acknowledgement signals dst_evt_ack.

Similarly, with regard to the examples of FIGS. 6 and 7, even though circuit 200a is indicated as the circuit generating request signals src_evt_req and using as a response the acknowledgement signals dst_evt_ack generated by circuit 200b, those skilled in the art will be capable of implementing, instead of circuit 200a, another circuit capable of generating requests src_evt_req and of managing as a response the respective acknowledgement signals dst_evt_ack originating from circuit 200a.

1. An electronic device, comprising:
a first circuit configured to:
generate, after at least one event has been received on a first node, a request signal of a handshake protocol on a second node; and
generate, after an acknowledgement signal of said handshake protocol has been received on a third node in response to said request signal, a first signal on a fourth node authorizing reception of at least one further event.

2. The device according to claim 1, wherein the first circuit is configured to operate with a first clock signal, and wherein the at least one event is in the form of a pulse having a duration shorter than or equal to one period of the first clock signal.

3. The device according to claim 2, wherein the first circuit comprises a first resynchronization cell having an input coupled to the third node and a clock input configured to receive the first clock signal.

4. The device according to claims claim 2, wherein the first circuit comprises:
a first multiplexer having a first input coupled to ground and a control input coupled to the first node; and
a first flip-flop having an output coupled to the fourth node and an input coupled to an output of the first multiplexer.

5. The device according to claim 4, wherein the first circuit further comprises:
a second multiplexer having a control input coupled to the first node, an output coupled to an input of a state storage element, a first input coupled to a first output of the state storage element, and a second input coupled, via an inverter, to a first output of the first resynchronization cell; and
wherein the state storage element has a second output, inverse to the first output, coupled to the second node.

6. The device according to claim 5, wherein:
a second input of the first multiplexer is coupled to an output of a third multiplexer;
a first input and a second input of the third multiplexer are respectively coupled to the fourth node and to a voltage rail configured to receive a first voltage;
the state storage element is a flip-flop; and
a control input of the third multiplexer is coupled to an output of a block configured so that if the request signal is at the same level as a second signal present on the first output of the first resynchronization cell, then the second input of the third multiplexer is selected.

7. The device according to claim 5, wherein the first circuit comprises a counter coupled to the first multiplexer and to the fourth node, and wherein the counter is configured to:
increment when an event is received on the first node;
decrement when the request signal is at the same level as a second signal present on the first output of the first resynchronization cell; and
activate the first signal as long as a threshold of the counter has not been reached, and deactivate it when said threshold has been reached.

8. The device according to claim 5, wherein the state storage element is a multi-bit register, or a memory operating according to the first-in-first-out principle, or a memory operating according to the last-in-first-out principle.

9. The device according to claim 1, further comprising a second circuit coupled to the first circuit, wherein the second circuit operates synchronously with the first clock signal, and is configured to generate events supplied to the first node of the first circuit as long as the first signal is activated, and to stop supplying events to the first node of the first circuit when the first signal is deactivated.

10. The device according to claim 1, further comprising a third circuit coupled to the first circuit, wherein the third circuit is configured to generate, as a response to the request signal of said handshake protocol, said acknowledgement signal of said handshake protocol on a fifth node.

11. The device according to claim 10, wherein the third circuit is configured to generate and output event, as a response to the request signal of said handshake protocol, on an output node of the third circuit.

12. The device according to claim 11, wherein the fifth node is coupled to the third node of the first circuit, and wherein the third circuit comprises:
a sixth node coupled to the second node of the first circuit;
a second resynchronization cell having a clock input configured to receive a second clock signal, an input coupled to the sixth node, and an output coupled to a logic block configured to obtain on the output node the result of an exclusive OR type function from the signal present on the fifth node and a third signal present on the output of the second resynchronization cell; and
a flip-flop having an input coupled to said output of the resynchronization cell, a clock input configured to receive the second clock signal, and an output coupled to the fifth node.

13. The device according to claim 1, wherein the electronic device is one of a microcontroller or an NFC circuit.

14. A method of operation of an electronic device, comprising:
generating, after at least one event has been received on a first node of a first circuit, a request signal of a handshake protocol on a second node of the first circuit; and
generating, after an acknowledgement signal of said handshake protocol has been received on a third node in response to said request signal, a first signal on a fourth node authorizing reception of at least one further event.

15. The method according to claim 14, wherein the first circuit is configured to operate with a first clock signal, and the at least one event is in the form of a pulse having a duration shorter than or equal to one period of the first clock signal.

16. The method according to claim 14, wherein the first circuit is coupled to a second circuit operating synchronously with the first clock signal, and further comprising:
generating by the second circuit events to be supplied to the first node of the first circuit as long as the first signal is activated, and
stopping supplying events to the first node of the first circuit when the first signal is deactivated.

17. The method according to claim 14, wherein the first circuit is coupled to a third circuit, the method further comprising generating by the third circuit said acknowledgement signal of said handshake protocol on a fifth node in response to the request signal of said handshake protocol.

18. The method according to claim 17, further comprising generating by the third circuit, in response to the request signal of said handshake protocol, an output event on an output node of the third circuit.

19. The method according to claim 14, wherein the electronic device is one of a microcontroller or an NFC circuit.
